(19) United States
(12) Patent Application Publication
(10) Pub. No.: US 2023/0132253 A1
(43) Pub. Date: Apr. 27, 2023

(54) WOOD COMPOSITE BLOCK, TRANSLUCENT WOOD VENEER AND METHOD FOR PRODUCING THE SAME

(71) Applicant: FRITZ KOHL GMBH & CO, KG, Karlstadt (DE)

(72) Inventor: Georg ROMBACH, Eussenheim (DE)

(21) Appl. No.: 17/437,690

(22) PCT Filed: Jun. 15, 2021
(86) PCT No.: PCT/EP2021/066021

§ 371 Date: Sep. 9, 2021

(30) Foreign Application Priority Data
Jun. 15, 2020 (DE) 10 2020 115 705.3

(51) Int. Cl. B32B 21/08; B27D 1/04; B32B 21/14; B32B 7/12; B32B 43/00; B32B 37/12; B32B 37/20

(52) U.S. Cl. CPC B32B 21/08; B27D 1/04; B32B 21/14; B32B 7/12; B32B 43/003; B32B 37/12; B32B 37/203; B32B 2250/05; B32B 2250/42; B32B 2307/202; B32B 2307/302; B32B 2307/412; B32B 2307/414; B32B 2307/536

(57) ABSTRACT

The invention relates to a multilayer wood composite block comprising a plurality of wood layers, wherein at least 5 wood layers of the plurality of wood layers have a layer thickness of 0.05 to 1 mm; a plurality of plastic layers, wherein at least 5 plastic layers of the plurality of plastic layers consist of translucent and/or transparent plastic and have a layer thickness of 0.05 to 1 mm; and a plurality of adhesive layers; wherein the wood and/or plastic layers are arranged in a superimposed manner; and wherein the adhesive layers are arranged between successive wood and/or plastic layers and bond them together; and a multilayer wood veneer.

The invention relates to a multi-layer wood composite block, a translucent wood veneer and methods of producing the same.

Multi-layer wood veneers obtained from multi-layer wood composite blocks are known.

DE 60 2005 001 689 T2 concerns a method for producing a veneer. According to this method, wood blocks are sliced into veneer with a thickness of about 0.65 mm after prolonged heating and soaking. Suitable adhesives mentioned include moisture-curing, thermal polyurethane adhesives.

The method described in DE 1 086 425 B for the production of finished wood veneers may optionally include slicing or round peeling of a multi-layered, glued wood block into individual veneers.

In EP 2 310 196 B1, a multi-layer wood block, veneers obtainable therefrom and methods for their production are described.

DE 10 2017 113 764 B4 discloses a method for producing a wood veneer and a veneer block, as well as a method for producing a moulded part. The veneer blocks are produced using an adhesive and then sliced into veneers.

DE 10 2015 009 012 B3 discloses a method for producing a veneer, the method comprising cutting off veneer sheets by means of a veneer slicing machine.

For economic reasons, wood veneers are preferably produced using a slicing process. This method saves material and produces veneers with a thickness of between 0.3 and 4 mm. However, the wood or veneer blocks must be heated and watered over an extended period of time to prepare them for slicing. Since this pre-treatment is accompanied by changes in temperature and humidity, which leads to a deformation, in particular expansion, of the individual layers of wood present in the veneer block, the achievable precision of sliced veneers is limited. In addition, this type of pre-treatment only permits the bonding of different materials to a limited extent, or the bonding often does not have the desired properties. In particular, adhesives that are both suitable for bonding different materials, such as wood, metals, plastics, and have sufficient resistance to moisture and/or heat during soaking or steaming, are not yet commercially available. Furthermore, the pre-treatment may be noticeable through colour changes in the wood. Last but not least, sliced veneers as well as round-peeled veneers often show cracks in the veneer. In principle, veneers are only obtainable by means of a slicing process up to a certain hardness of the wood or wood (composite) block used; ironwood, in particular, i.e. various tropical woods, cannot be sliced into veneers, but can only be processed by sawing.

Multi-layer sawn veneers are also known from the prior art. The sawing of wood (composite) blocks into veneers represents the most original method. One disadvantage of sawing is the comparatively large loss of material, which depends, among other things, on the thickness of the saw blade used. Overall, sawing is considerably more time-consuming. However, sawn veneers retain their colours and are largely free of cracks, as they do not necessarily have to be dried. Sawn veneers can usually be produced with a thickness of 1 mm or more and are mainly used for high-quality and highly stressed workpieces, e.g. in furniture construction or for floor coverings.

Also known are translucent wooden decorative elements. US 2013/0196119 A1 discloses translucent, bendable wooden decorative panels that are essentially composed of two very thin layers of wood and a translucent substrate that is not made of wood and is arranged between the two layers of wood. The wood layers used must be extremely thin in order to ensure the desired transparency of the decorative element. In addition, the options with regards to design and dimensions are limited.

### DESCRIPTION OF THE INVENTION

The present invention is based on the task of providing a multi-layer wood composite block which is suitable as a starting material for the production of a translucent veneer. A further task of the invention is to provide a translucent, multi-layer wood veneer which can be used for decorative parts and/or trim parts, for example.

The present invention is essentially based on the realisation that by selecting and arranging the materials in relation to one another according to the invention and by positioning the layers of the multi-layer wood composite block or wood veneer in the room, it is possible to provide a decorative element, for example, that has a high-quality natural wood surface and can be backlit.

The orientation of the layers of the multi-layer wood composite block or wood veneer is perpendicular to the normal of the cutting plane for the wood composite block or perpendicular to the normal of the surface of the wood veneer. With reference to an xyz coordinate system, the surface of the wood veneer extends in the section spanned by the x- and z-axes such that the layers of the multi-layer wood veneer extend axially along the x-axis. The wood layers and/or plastic layers are thus arranged in a superimposed manner along the z-axis.

The present task is solved by the wood composite block according to claim 1, the multi-layer wood veneers according to claim 7 and the methods according to claims 13 and 15.

A first aspect of the invention relates to a wood composite block comprising a plurality of wood layers, wherein at least 5, preferably at least 10 and more preferably at least 15 wood layers of the plurality of wood layers have a layer thickness of from 0.05 to 1.0 mm, preferably from 0.1 to 0.75 mm and more preferably from 0.15 to 0.5 mm;

a plurality of plastic layers, wherein at least 5, preferably at least 10 and more preferably at least 15 plastic layers of the plurality of plastic layers consist of translucent and/or transparent plastic and have a layer thickness of 0.05 to 1.0 mm, preferably 0.1 to 0.75 mm and more preferably 0.15 to 0.5 mm; and a plurality of adhesive layers;

wherein the wood layers and/or plastic layers are arranged in a superimposed manner; and

wherein the adhesive layers are arranged between successive wood layers and/or plastic layers and bond them together.

Advantageous embodiments and improvements are indicated in the corresponding dependent claims.

The thickness of a layer, also referred to as the layer thickness, may be the same over the entire area of the layer. However, the thickness of a layer may also vary. For example, a layer may have a rectangular, wedge-shaped, round or curved cross-section. In principle, the shape and thickness of the individual layers are freely selectable, for example depending on the desired design. In the context of the present invention, the term “layer thickness” refers to the thickness of the individual layer. With reference to the xyz coordinate system, the thickness of the respective layer thus extends along the z-axis.

This applies in the same way to the wood, plastic and adhesive layers contained in the wood composite block, as well as to the—optional—intermediate layers.

In order to ensure that the multi-layer wood veneer obtained from the wood composite block has the desired translucency on the one hand, but gives the optical impression of a conventional wood veneer on the other hand, the layer thicknesses of wood and plastic layers must each be in the range of 0.05 to 1.0 mm, preferably 0.1 to 0.75 mm and even more preferably 0.15 to 0.5 mm.

According to a preferred embodiment, the wood composite block comprises a plurality of wood layers, a plurality of plastic layers and a plurality of adhesive layers, wherein at least 5, preferably at least 10, more preferably at least 15 wood layers of the plurality of wood layers and at least 5, preferably at least 10, more preferably at least 15 plastic layers of the plurality of plastic layers are alternately arranged.

The alternating arrangement of a plurality of wood and plastic layers opens up additional design options on the one hand, as each of the layers always forms a line element in the wood composite block as well, and on the other hand such an arrangement leads to a particularly good balance between light transmission and the desired visual impression (veneer effect).

According to a further preferred embodiment, the wood composite block has at least one, preferably more than one, more preferably all of the following properties:
the colour shift upon transillumination by a white LED of at least 5, preferably at least 10, more preferably at least 15 plastic layers of the plurality of plastic layers essentially lies on a black body curve; and/or
at least one of the wood layers, the plastic layers and/or the adhesive layers is electrically conductive; and/or
at least one intermediate layer is arranged between the plurality of wood layers and/or plastic layers, wherein the at least one intermediate layer is preferably electrically and/or thermally conductive.

Preferably, the colour shift lies on a black body curve when the plastic layer(s) is/are transilluminated by a white LED, in particular an LED with a colour temperature of 4000 to 6000 K. By the term ‘essentially’ it is meant that the colour shift lies within so-called “colour bins” according to ANSI C78.377-2008. Such a shift can be compensated for particularly easily by using a suitable coloured light source. Alternatively, the CIE standard valence system may be used. Here, the white point is x=y=z=0.333. Deviations in transmitted light caused by plastic layers should then have the following parameters: dx<0.15; dy<0.15; dz<0.15; preferably <0.10 each; most preferably <0.05 each.

By ‘thermally conductive intermediate layers’, in particular such layers are meant that consist of materials that have a thermal conductivity, A, in the range of greater than or equal to 30 W/m*K. The thermal conductivity A can be determined using Fourier's law or by measuring methods known to the skilled person. Suitable materials include, for example, metals and metal alloys, carbon (graphite, graphene), silicon and ceramic materials (e.g. aluminium nitride, silicon carbide, corundum).

The use of intermediate layers opens up additional design options, as each intermediate layer always forms a line element in the wood composite block as well. Furthermore, the intermediate layers may have an influence on the processing properties of the wood composite block.

Preferably, the at least one intermediate layer consists of metal, textile, plastic, leather, fleece, stone, felt, pressed paper, solid surface material, medium density (wood) fibreboard (MDF), or combinations thereof.

A particularly suitable pressed paper is the one made by the US company Richlite (https://richlite.com).

Within the wood composite block according to the invention, the at least one intermediate layer may be arranged between two wood layers in such a way that the intermediate layer is bonded to a first wood layer by a first adhesive layer and to a second wood layer by a second adhesive layer, i.e. the intermediate layer is embedded in an adhesive layer bonding two wood layers together. Alternatively, the at least one intermediate layer may be arranged in an analogous manner between a wood layer and a plastic layer or between two plastic layers.

By introducing electrically and/or thermally conductive intermediate layers, additional functionalities become accessible. In particular, such conductive intermediate layers may serve as an “interface” with other components. In this context, it is particularly preferred that the multi-layer wood veneer has at least one means for proximity and/or touch detection. The means for proximity and/or touch detection most preferably comprises a proximity and/or touch sensor and an analysing unit.

Further preferably, a conductor element, in particular in the form of a printed circuit board, may be provided.

According to a further preferred embodiment, the plastic of at least 5, preferably at least 10, more preferably at least 15 and most preferably all plastic layers of the plurality of plastic layers is selected from the group consisting of polyolefins, polycarbonates, polyesters, polyurethanes, polyphenylsulphides, epoxides and combinations thereof, preferably polycarbonates; and/or

at least 5, preferably at least 10, more preferably at least 15 and most preferably all plastic layers of the plurality of plastic layers consist of plastic film, preferably polycarbonate film.

Properties such as high transparency, high strength, high heat resistance and good dimensional stability are decisive for the selection of plastics.

Due to lower water absorption, for example in comparison to PMMA, in particular polycarbonate, which has a low tendency to warp, high heat resistance and impact strength, is preferred.

According to a further preferred embodiment, the wood composite block has a total carbon emission (TVOC—Total Volatile Organic Compounds) of less than or equal to 50 μg carbon/g determined in accordance with VDA 277, and/or a content of volatile hydrocarbons (VOC—Volatile Organic Compounds) of less than or equal to 100 mg/kg and semi-volatile hydrocarbons (FOG—Fogging or SVOC—Semi-Volatile Organic Compounds) of less than or equal to 250 mg/kg determined in accordance with VDA 278,

and/or a formaldehyde emission value of less than or equal to 3 mg/kg determined in accordance with VDA 275; and/or

the adhesive layers have a hardness of at least 70 Shore A in the cured state, determined in accordance with DIN EN ISO 868:2003-10, and/or a hardness of at least 20 Shore D, determined in accordance with DIN EN ISO 868:2003-10.

The above emission values TVOC, VOC, FOG and the formaldehyde emission value of the wood composite block according to the invention may also be, independently of each other, equal to zero.

Experts distinguish volatile hydrocarbons (VOC—Volatile Organic Compounds) from Very Volatile Organic Compounds (VVOC) and Semi-volatile Organic Compounds (SVOC). The sum of the concentrations of all volatile hydrocarbons is the TVOC value (Total Volatile Organic Compounds).

The term VOC summarises volatile organic compounds that have a boiling point range of 50-100° C. to 250-260° C. FOG and/or SVOC are referred to as organic compounds that have a boiling point range of 240° C. to 400° C. and may form a precipitate (lubricating film).

A wood composite block that meets the above criteria with regard to the emission tests according to VDA 275, 277 and/or 278 has a low toxicity. Such a wood composite block is therefore suitable for a wide variety of uses, especially indoors. For example, the wood composite block is suitable for the production of decorative parts and/or trim parts for a vehicle interior.

The hardness of the adhesive layers is an important criterion for the machinability of the multi-layer wood composite block. If the cured adhesive layers of the wood composite block are too soft, sawing is no longer possible because the adhesive layers smear and/or the sawn veneers do not hold their shape. However, if the adhesive layers are too hard, sawing is no longer possible and/or the wear on the tools used is enormous. In order to ensure that the multi-layer wood composite block according to the invention is machinable—in particular by means of sawing or slicing—it is necessary that the adhesive layers, in the cured state, have a hardness of at least 70 Shore A and/or a hardness of at least 20 Shore D, preferably at least 75 Shore A and/or at least 24 Shore D, more preferably at least 80 Shore A and/or at least 27 Shore D.

Preferably, the hardness of the adhesive layers, in the cured state, is less than or equal to 60 Shore D.

Preferably, the hardness of the adhesive layers, in the cured state, is less than or equal to 100 Shore A.

The hardness, Shore A and Shore D, is measured according to DIN EN ISO 868:2003-10.

In contrast to veneer production by means of slicing, sawing eliminates the need for pre-treatment of the wood composite blocks, i.e. temperature and/or humidity fluctuations are avoided so that deformation and/or discolouration of the blocks does not occur. Thus, sawn veneers can be produced with higher precision. Also, the type of wood composite structure and the production of veneers by sawing allows designs that were not possible with previously known methods.

In principle, all adhesives suitable for gluing wood are suitable for implementing the present invention. Since moisture fluctuations, or swelling and/or warping of the wood, should be avoided, water- and solvent-free adhesives are preferred.

Preferably, the at least one adhesive layer is produced with water- and solvent-free adhesives. Any residual amounts of water and/or solvent contained are non-removable residual amounts or, for example, amounts of water introduced by the humidity of the air.

The adhesive properties of the adhesives also play a role. The surface properties such as polarity and structure of different materials, i.e. in particular different woods and plastics, but also other materials that may be introduced as intermediate layers in the multi-layer wood composite block or in the multi-layer wood veneer, may differ significantly. When selecting suitable adhesives, these must therefore have sufficient adhesive strength to all materials used.

Suitable adhesives include polyurethanes (PUR), epoxy resins, silane-modified polymers or two-component adhesives such as PVAc copolymer with isocyanate. Hot-melt adhesives based on polyurethane prepolymers and epoxy resins are particularly suitable.

Particularly preferred are moisture-curing hot-melt adhesives based on polyurethane prepolymers, which have a processing temperature of 100-140° C., and/or which have a viscosity before curing of 5000 to 20000 mPas, preferably from 5000 to 16000 mPas, more preferably from 8000 to 16000 mPas at 130° C. (Brookfield DV-II+Thermosel, spindle 29), and/or which have a density before curing of from 1.0 to 1.5 g/cm³, preferably from 1.0 to 1.3 g/cm³, more preferably from 1.1 to 1.3 g/cm³.

In principle, the adhesive layers are used to bond one layer of wood or plastic to another layer of wood or plastic.

According to a further preferred embodiment, the plurality of adhesive layers is translucent and/or transparent; colourable and/or temperature-resistant up to 180° C., preferably 190° C., more preferably 200° C. and even more preferably 220° C.

The advantage of translucent and/or transparent adhesive layers is the improved light transmission of the finished product, i.e. the multi-layer veneer.

Colourable adhesive layers allow the suppression of the potential occurrence of yellowing and/or the prevention of partial or total light penetration. This is the case, for example, when an adhesive layer is coloured using a black pigment. Then, possibly occurring yellowing effects are no longer visible. Furthermore, colourable adhesive layers open up additional design options, as an adhesive layer always forms a line element in the wood composite block as well.

The temperature resistance of the adhesive layers prevents yellowing effects, since—even with stronger, natural fluctuations in the ambient temperature—no or only very small amounts of decomposition products are present in the adhesive layers. Here, however, temperature resistance does not only include the decomposition of the adhesive layers, but also their dimensional stability. This means that an adhesive layer that is temperature-resistant up to 180° C. neither softens (does not melt), nor does thermal decomposition of the adhesive layer occur. Adhesive coatings that are temperature-resistant up to 180° C. open up additional options in terms of machining methods.

Preferably, the at least one adhesive layer is colourable and temperature-resistant up to 180° C., preferably 190° C., more preferably 200° C. and even more preferably 220° C., so that potential impairment of the appearance by yellowing is prevented.

Another aspect of the invention relates to a multi-layer translucent wood veneer, comprising:

a plurality of layers of wood,

wherein at least 5, preferably at least 10 and more preferably at least 15 wood layers of the plurality of wood layers have a layer thickness of 0.05 to 1 mm, preferably 0.1 to 0.75 mm and more preferably 0.15 to 0.5 mm;

a plurality of plastic layers, wherein at least 5, preferably at least 10 and more preferably 15 plastic layers of the plurality of plastic layers consist of translucent and/or transparent plastic and have a layer thickness of 0.05 to 1 mm, preferably 0.1 to 0.75 mm and more preferably 0.15 to 0.5 mm; and

a plurality of adhesive layers;

wherein the wood layers and/or plastic layers are arranged in a superimposed manner; and

wherein the adhesive layers are arranged between successive wood layers and/or plastic layers and bond them together.

The technical effects correlating with the layer thickness of the wood and plastic layers—as described for the wood composite block according to the invention—are also valid with regard to the multi-layer wood veneer.

According to a preferred embodiment, the multi-layer wood veneer according to the invention has a thickness between 0.1 and 2.0 mm, preferably between 0.2 and 1.5 mm, more preferably between 0.3 and 1.0 mm and even more preferably between 0.3 and 0.8 mm; and/or

at least 5, preferably at least 10, more preferably at least 15 wood layers of the plurality of wood layers and at least 5, preferably at least 10, more preferably at least 15 plastic layers of the plurality of plastic layers are arranged alternately.

With veneer thicknesses of less than or equal to 2.0 mm, the wood veneers are still sufficiently flexible to be bent into shape, e.g. for applications as decorative parts and/or trim parts, especially for vehicle interiors. At the same time, the material consumption for veneers with a thickness of less than or equal to 2.0 mm is relatively low.

Furthermore, it should be noted that the wood veneer according to the invention is preferably manufactured with high precision, i.e. it has a thickness tolerance of less than or equal to 0.25 mm, preferably less than or equal to 0.20 mm and more preferably less than or equal to 0.15 mm.

For the purposes of the present invention, the term “thickness” means the thickness of the multi-layer wood veneer. With reference to the xyz coordinate system, the thickness of the multi-layer wood veneer thus extends along the y-axis.

According to a further preferred embodiment, the translucent wood veneer has at least one, preferably more than one, more preferably all of the following properties:

the colour shift upon transillumination by a white LED of at least 5, preferably at least 10, more preferably at least 15 plastic layers of the plurality of plastic layers essentially lies on a black body curve; and/or at least one of the wood layers, the plastic layers and/or the adhesive layers is electrically conductive; and/or

at least one intermediate layer is arranged between the plurality of wood layers and/or plastic layers, wherein the at least one intermediate layer is preferably electrically and/or thermally conductive.

According to a further preferred embodiment, the plastic of at least 5, preferably at least 10, more preferably at least 15 and most preferably all plastic layers of the plurality of plastic layers within the translucent wood veneer according to the invention is selected from the group consisting of polyolefins, polycarbonates, polyesters, polyurethanes, polyphenylsulphides, epoxides and combinations thereof, preferably polycarbonates; and/or at least 5, preferably at least 10, more preferably at least 15 and most preferably all plastic layers of the plurality of plastic layers within the translucent wood veneer according to the invention consist of plastic film, preferably polycarbonate film.

The selection criteria for the plastic layers in the wood veneer are analogous to those for the multi-layer wood composite block.

According to a further preferred embodiment, the translucent wood veneer has a total carbon emission (TVOC—total volatile organic compounds) of less than or equal to 50 μg carbon/g determined according to VDA 277, and/or a volatile hydrocarbon content (VOC—volatile organic compounds) of less than or equal to 100 mg/kg and a semi-volatile hydrocarbon content (FOG—fogging or SVOC—semi-volatile organic compounds) of less than or equal to 250 mg/kg determined in accordance with VDA 278, and/or a formaldehyde emission value of less than or equal to 3 mg/kg determined in accordance with VDA 275; and/or the adhesive layers have a cured hardness of at least 70 Shore A, determined in accordance with DIN EN ISO 868:2003-10, and/or a hardness of at least 20 Shore D, determined in accordance with DIN EN ISO 868:2003-10.

The above emission values TVOC, VOC, FOG and the formaldehyde emission value of the multi-layer wood veneer may also be, independently of each other, equal to zero.

The technical effects correlating with the above-mentioned preferred embodiments—as described for the wood composite block according to the invention—are also valid with respect to the multi-layer translucent wood veneer.

Another aspect of the invention relates to a method of manufacturing a multi-layer wood composite block according to the invention as claimed in claims 1 to 6, comprising the steps of providing a plurality of plastic layers and dry wood layers and gluing the plastic layers and dry wood layers together.

Because the wood layers are dry and dry-glued during the method for producing the multi-layer wood composite block according to the invention, deformation and/or discolouration of the wood layers caused by moisture can be avoided.

The wood composite block or the individual wood layers have a wood moisture content of less than or equal to 20%, preferably less than or equal to 18%, more preferably less than or equal to 15%, even more preferably between 6 and 15%.

The wood moisture is measured by means of a commercially available measuring device (Gann Hydromette, H35-M20), which determines the wood moisture on the basis of the electrical resistance (DIN EN 13183-2:2002-07 with DIN EN 13183-2 Corrigendum 1: 2003-12).

Alternatively, the wood moisture can also be determined by means of kiln-drying (DIN EN 13183-1:2002-07 with DIN EN 13183-1 Corrigendum 1:2003-12).

Preferably, (cut to size) dry wood layers and/or (cut to size) plastic layers and/or (cut to size) intermediate layers are calibrated before dry gluing and/or the cured wood composite block is calibrated after dry gluing.

Even more preferably, both the (cut to size) dry wood layers, the (cut to size) plastic layers and the (cut to size) intermediate layers are calibrated before dry gluing and the cured wood composite block is calibrated after dry gluing.

The details given above on the wood composite block according to the invention also apply accordingly to the method for producing the multi-layer wood composite block.

According to a preferred embodiment, the individual wood and plastic layers are layered on top of or next to each other using a die, wherein the die is designed in such a way that it prevents the wood and plastic layers from slipping.

With the use of a die, slipping of the layers during gluing is prevented, so that the desired precision can be ensured.

A further aspect of the invention relates to a method of producing a multi-layer translucent wood veneer, comprising cutting a multi-layer wood composite block according to the invention as claimed in any one of claims 1 to 6 to form translucent wood veneers.

According to a preferred embodiment, the wood composite block is sawn or sliced, preferably sawn, into multi-layer translucent wood veneer.

According to a further preferred embodiment, the processing, in particular the cutting of the multi-layer wood composite block, takes place in the dry state.

Sawing veneers, unlike slicing, does not require any pre-treatment such as soaking and/or steaming of the wood composite block. Consequently, the wood composite block is not exposed to temperature and/or humidity fluctuations that could lead to a deformation and/or discolouration of the composite block or the individual veneer sheets. Due to the fact that thermal pre-treatment of the multi-layer wood composite block is not required, the choice of adhesives that can be used is less limited than with the conventional slicing process. Due to this extended selection, adhesives can also be used that have particularly advantageous adhesive properties with respect to different materials, i.e. not only for wood, but also for the materials used as intermediate layers. Thus, the method according to the invention offers more design options with regard to possible material combinations and, correspondingly, accessible designs.

In addition, sawing offers the advantage that cracking is avoided and a wider range of materials can be used in the production of the multi-layer veneers. Very hard materials such as ironwood, that is, various tropical woods, metals and hard plastics, can be sawn but not sliced.

The wood composite block is sawn in order to cut it into multi-layered wood veneers, wherein the sawing is preferably carried out with a band saw, for example a horizontal band saw.

According to an improved design, the cutting of the wood composite block is carried out at an angle of 0° to 180° to the cutting surfaces of the wood layers, in particular at an angle of between 45° and 135° to the cutting surfaces of the wood layers. Particularly preferably, the cutting of the wood composite block is carried out perpendicular to the cutting surface of the wood layers.

The wood composite block according to the invention preferably remains dry during the entire processing, i.e. no water-based or solvent-based adhesive is used, nor is the wood composite block watered.

The details given above on the wood veneer according to the invention also apply accordingly to the method for producing the multi-layer wood veneer.

Another aspect of the invention relates to a wood veneer obtainable by the method of producing a multi-layer wood veneer according to the invention.

The technical effects or advantages of such a wood veneer according to the invention are analogous to those described for the method.

The wood veneer according to the invention can be used, for example, as a decorative element and/or trim element in furniture construction, in interior fittings, in articles of daily use such as mobile phones and corresponding protective covers, but also in the field of textile and leather goods.

Preferably, the multi-layer wood veneer according to the invention is used as a decorative element and/or trim element in a vehicle interior.

The invention and the technical field will be explained in more detail below with reference to the figures. It should be noted that the invention is not intended to be limited by the embodiments shown. In particular, unless explicitly shown otherwise, it is also possible to extract partial aspects of the facts explained in the figures and combine them with other components and findings from the present description and/or figures. In particular, it should be noted that the figures and especially the proportions shown are only schematic. Identical reference signs designate identical subject matters, so that explanations from other figures can be used as a supplement if necessary. Shown are:

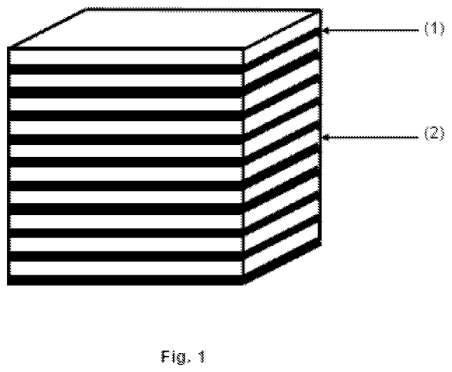

FIG. 1 Schematic representation of a multi-layer wood composite block according to the invention.

FIG. 1 shows a wood composite block according to the invention. The wood composite block shown comprises a plurality of wood layers (1 or 1a, 1b, . . . ) and a plurality of plastic layers (2 or 2a, 2b, . . . ). Each of the layers (1a, 1b, . . . ) and (2a, 2b, . . . ) has a thickness (dx with x=1a, 1b, . . . 2a, 2b, . . . ), wherein (dx) can be chosen for each type of layer (1) and (2) as well as for each individual layer (1a), (1b), (1c) independently of the thickness (dx) of the other layers.

Only one plastic layer (2) can be provided between two wood layers (1a, 1b), by means of which the wood layers (1a, 1b) are glued together. This plastic layer (2) then forms a visible line element in the finished multi-layer wood veneer. Optionally, the plastic layer (2) can be coloured to make further design alternatives accessible.

The layers (1a, 1b, . . . ) and (2a, 2b, . . . ) are connected to each other by adhesive layers (not shown).

### LIST OF REFERENCE SIGNS

1 wood layer
2 plastic layer

1-17. (canceled)

18. Multi-layer wood composite block comprising
a plurality of layers of wood, wherein at least 5, preferably at least 10 and more preferably at least 15 wood layers of the plurality of wood layers have a layer thickness of 0.05 to 1 mm, preferably 0.1 to 0.75 mm and more preferably 0.15 to 0.5 mm;
a plurality of plastic layers, wherein at least 5, preferably at least 10 and more preferably at least 15 plastic layers of the plurality of plastic layers consist of translucent and/or transparent plastic and have a layer thickness of 0.05 to 1 mm, preferably 0.1 to 0.75 mm and more preferably 0.15 to 0.5 mm; and
a plurality of adhesive layers;
wherein the wood and/or plastic layers are arranged in a superimposed manner; and wherein the adhesive layers are arranged between successive wood and/or plastic layers and bond them together, and wherein the adhesive layers in the cured state have a hardness of at least 70 Shore A, determined in accordance with DIN EN ISO 868: 2003-10, and/or a hardness of at least 20 Shore D, determined in accordance with DIN EN ISO 868: 2003-10.

19. Multi-layer wood composite block according to claim 18, wherein at least 5, preferably at least 10, more preferably at least 15 wood layers of the plurality of wood layers and at least 5, preferably at least 10, more preferably at least 15 plastic layers of the plurality of plastic layers are arranged alternately.

20. Multi-layer wood composite block according to claim 18,
wherein a colour shift upon transillumination by a white LED of at least 5, preferably at least 10, more preferably at least 15 plastic layers of the plurality of plastic layers essentially lies on a black body curve; and/or
wherein at least one of the wood layers, the plastic layers and/or the adhesive layers is electrically conductive; and/or
wherein at least one intermediate layer is arranged between the plurality of wood layers and/or plastic layers, wherein the at least one intermediate layer is preferably electrically and/or thermally conductive.

21. Multi-layer wood composite block according to claim 18,
wherein the plastic of at least 5, preferably at least 10, more preferably at least 15 and most preferably all plastic layers of the plurality of plastic layers is selected from the group consisting of polyolefins, polycarbonates, polyesters, polyurethanes, polyphenylsulphides, epoxides and combinations thereof, preferably polycarbonates; and/or
wherein at least 5, preferably at least 10, more preferably at least 15 and most preferably all plastic layers of the plurality of plastic layers consist of plastic film, preferably polycarbonate film.

22. Multi-layer wood composite block according to claim 18, wherein the wood composite block has
a) a total carbon emission (TVOC, Total Volatile Organic Compounds) of less than or equal to 50 μg carbon/g determined according to VDA 277,
and/or
(b) a content of volatile organic compounds (VOC) of less than or equal to 100 mg/kg and semi-volatile organic compounds (FOG—Fogging) of less than or equal to 250 mg/kg determined in accordance with VDA 278; and/or
(c) a formaldehyde emission value of less than or equal to 3 mg/kg determined in accordance with VDA 275.

23. Multi-layer wood composite block according to claim 18,
wherein the adhesive layers are translucent and/or transparent; and/or
wherein the adhesive layers may be coloured; and/or
wherein the adhesive layers are temperature-resistant up to 180° C.

24. Multi-layer wood veneer, comprising:
a plurality of layers of wood, wherein at least 5, preferably at least 10 and more preferably at least 15 wood layers of the plurality of wood layers have a layer thickness of 0.05 to 1 mm, preferably 0.1 to 0.75 mm and more preferably 0.15 to 0.5 mm;
a plurality of plastic layers, wherein at least 5, preferably at least 10 and more preferably 15 plastic layers of the plurality of plastic layers consist of translucent and/or transparent plastic and have a layer thickness of 0.05 to 1 mm, preferably 0.1 to 0.75 mm and more preferably 0.15 to 0.5 mm; and
a plurality of adhesive layers;
wherein the wood layers and/or plastic layers are arranged in a superimposed manner; and wherein the adhesive layers are arranged between successive wood layers and/or plastic layers and bond them together, and wherein the adhesive layers in the cured state have a hardness of at least 70 Shore A, determined in accordance with DIN EN ISO 868: 2003-10, and/or a hardness of at least 20 Shore D, determined in accordance with DIN EN ISO 868: 2003-10.

25. Multi-layer wood veneer according to claim 24,
wherein the multi-layer wood veneer has a thickness between 0.1 and 2.0 mm, preferably between 0.2 and 1.5 mm, more preferably between 0.3 and 1.0 mm and even more preferably between 0.3 and 0.8 mm; and/or
wherein at least 5, preferably at least 10, more preferably at least 15 wood layers of the plurality of wood layers and at least 5, preferably at least 10, more preferably at least 15 plastic layers of the plurality of plastic layers are arranged alternately.

26. Multi-layer wood veneer according to claim 24,
wherein a colour shift upon transillumination by a white LED of at least 5, preferably at least 10, more preferably at least 15 plastic layers of the plurality of plastic layers essentially lies on a black body curve; and/or
wherein at least one of the wood layers, the plastic layers and/or the adhesive layers is electrically conductive; and/or
wherein at least one intermediate layer is arranged between the plurality of wood layers and/or plastic layers, wherein the at least one intermediate layer is preferably electrically and/or thermally conductive.

27. Multi-layer wood veneer according to claim 24,
wherein the plastic of at least 5, preferably at least 10, more preferably at least 15 and most preferably all plastic layers of the plurality of plastic layers is selected from the group consisting of polyolefins, polycarbonates, polyesters, polyurethanes, polyphenylsulphides, epoxides and combinations thereof, preferably polycarbonates; and/or
wherein at least 5, preferably at least 10, more preferably at least 15 and most preferably all plastic layers of the plurality of plastic layers consist of plastic film, preferably polycarbonate film.

28. Multi-layer wood veneer according to claim 24,
wherein the wood veneer has
(a) a total carbon emission (TVOC—Total Volatile Organic Compounds) of less than or equal to 50 μg carbon/g determined in accordance with VDA 277, and/or
(b) a content of volatile organic compounds (VOC) of less than or equal to 100 mg/kg and semi-volatile organic compounds (FOG—Fogging) of less than or equal to 250 mg/kg determined in accordance with VDA 278; and/or
(c) a formaldehyde emission value of less than or equal to 3 mg/kg determined in accordance with VDA 275.

29. Multi-layer wood veneer according to claim 24,
wherein the adhesive layers are translucent and/or transparent; and/or
wherein the at least one adhesive layer is colourable; and/or
wherein the at least one adhesive layer is temperature-resistant up to 180° C.

30. Method for producing a multi-layer wood composite block according to claim 18, comprising the steps of:
a) providing a plurality of plastic layers and dry wood layers;
b) gluing the plastic layers and dry wood layers together.

31. Method for producing a multi-layer wood composite block according to claim 30, wherein the individual wood layers are layered on top of and/or next to one another using a die, the die being designed in such a way that it prevents the wood layers from slipping.

32. Method for producing a multi-layer wood veneer comprising cutting a multi-layer wood composite block according to claim 18 into multi-layer wood veneers.

33. Method for producing a multi-layer wood veneer according to claim 32,
wherein the wood composite block is sawn or sliced, preferably sawn, into multi-layer wood veneer; and/or
wherein the processing, in particular the cutting of the multi-layer wood composite block, is carried out in the dry state.

34. Wood veneer obtained by the method for producing a multi-layer wood veneer according to claim 32.
